(19) United States
(12) Patent Application Publication
(10) Pub. No.: US 2024/0217647 A1
(43) Pub. Date: Jul. 4, 2024

(54) SOUND INSULATING GLAZING FOR AN AIRCRAFT

(71) Applicant: SAINT-GOBAIN GLASS FRANCE, COURBEVOIE (FR)

(72) Inventors: Gary JACQUS, PARIS (FR); Volodymyr IURASOV, VINCENNES (FR); Sylvain BERGER, PARIS (FR)

(21) Appl. No.: 18/557,689

(22) PCT Filed: Apr. 29, 2022
(86) PCT No.: PCT/FR2022/050835

§ 371 Date: Oct. 27, 2023

(30) Foreign Application Priority Data
Apr. 29, 2021 (FR) FR2104521

(51) Int. Cl. B64C 1/14; G10K 11/162

(52) U.S. Cl. CPC B64C 1/1492; G10K 11/162

(57) ABSTRACT

A glazed unit extending along a main surface and formed by a first material, includes a soundproofing zone that extends along a first length l along the main surface, the soundproofing zone having a first thickness h₁ of the material, the first thickness h₁ varying, as a function of a coordinate x, along the first length l in proportion to a value of xⁿ, where n is a real number strictly greater than 1, from a minimum thickness h₁ₘᵢₙ to a maximum thickness h₁ₘₐₓ, the first length l being predetermined such that the minimum thickness h₁ₘᵢₙ is less than or equal to one third of the maximum thickness h₁ₘₐₓ.

### FIELD OF THE INVENTION

The present invention relates to an aircraft glazed unit having soundproofing properties, and more particularly to an aircraft window or windshield comprising a glazed unit having such properties.

### STATE OF THE ART

Referring to FIG. 1, it is known to mount a glazed element 1, preferably a window 12 or a windshield 13, to the fuselage of an aircraft. The window 12 may comprise an exterior glazed unit 2, and an interior glazed unit 2, which are mounted on a metal frame 14 in a seal 15. The seal 15 covers the border of the exterior glazed unit 2 and of the interior glazed unit 2. The seal 15 is held by a metal profile 16 mounted on an articulation 17, which is fixedly mounted to the metal frame 14.

The soundproofing of an aircraft glazed element may depend on several parameters: a variation in the temperature outside the aircraft, a variation in temperature inside the aircraft, mechanical stresses at the limit of the glazed element, the geometry and the composition of the glazed element, and/or a variation of the characteristics of the materials of the glazed element with the temperature and the mechanical stresses imposed on the glazed element. Thus, modeling the soundproofing properties of a glazed element can be complex.

It is known to improve the soundproofing of an aircraft glazed element by increasing the thickness of a glazed unit of the glazed element.

However, the increase in the thickness of the exterior glazed unit 2 is limited by the bulk of the exterior glazed unit 2 in the window 2 and by the costs that the increase in this thickness incurs.

### OVERVIEW OF THE INVENTION

One aim of the invention is to propose a glazed element having a soundproofing greater than that of a known glazed element, at least in an audible frequency range.

This aim is achieved in the context of the present invention owing to a glazed unit extending along a main surface and formed by a first material, the glazed unit comprising a soundproofing zone that extends along a first length l along the main surface, the soundproofing zone having a first thickness h₁ of the material, the first thickness h₁ varying, as a function of a coordinate x, along the first length l in proportion to a value of xⁿ, where n is a real number strictly greater than 1, from a minimum thickness h₁ₘᵢₙ to a maximum thickness h₁ₘₐₓ, the first length l being predetermined such that the minimum thickness h₁ₘᵢₙ is less than or equal to one third of the maximum thickness h₁ₘₐₓ.

The present invention is advantageously completed by the following features, considered individually or in any technically possible combination:
the glazed unit comprises a central part and a peripheral part, the peripheral part being arranged at the periphery of the central part relative to the main surface and in direct contact with the central part, the central part having a first thickness h₁ₘₐₓ of the material in contact with the peripheral part, and the peripheral part comprising the soundproofing zone,
the glazed unit is a monolithic aircraft glazed unit,
the first material is isotropic,
n is strictly greater than 5/3, and preferentially strictly greater than 2,
n is strictly less than 100,
the soundproofing zone forms a thinning of the glazed unit from the central part to a border of the glazed unit, and n preferentially being a real number greater than or equal to 2,
the central part has two opposite edges, and the peripheral part is arranged in contact with the two edges, the peripheral part preferentially surrounding the central part,
the soundproofing zone has at least one recess, n being preferentially a real number greater than or equal to 5/3,
the recess has an elliptical and preferentially circular shape,
a cut-out is formed at the center of the recess,
the glazed unit comprises a visco-elastic dissipator, the dissipator being fixedly mounted in contact with at least part of the soundproofing zone, the dissipator being formed by a visco-elastic material having a first loss factor η₁ strictly greater than 0.05, in particular strictly greater than 0.10 and preferentially strictly greater than 0.15.

Another aspect of the invention is a glazed element, comprising at least two glazed units, each glazed unit being a glazed unit according to one embodiment of the invention, the two glazed units being superimposed, the glazed element comprising at least one spacer configured to separate the two glazed units.

Advantageously, the spacer is formed by a material having a value of the real part E′ of the Young's modulus less than 20 MPa.

Another aspect of the invention is an aircraft window, comprising a glazed unit according to one embodiment of the invention.

Another aspect of the invention is an aircraft windshield, comprising a glazed unit according to one embodiment of the invention.

### DESCRIPTION OF THE FIGURES

Other features, purposes and advantages of the invention will emerge from the following description, which is purely illustrative and non-limiting, and which must be read in conjunction with the appended drawings in which:

FIG. 1 schematically shows a cross-section of a known window,

FIG. 2 schematically shows a cross-section of a glazed unit according to one embodiment of the invention,

FIG. 3 schematically shows a glazed unit according to one embodiment of the invention,

FIG. 4 schematically shows a glazed unit according to one embodiment of the invention,

FIG. 5 schematically shows a cross-section of a soundproofing zone of a glazed unit according to one embodiment of the invention, wherein the soundproofing zone forms a thinning of the glazed unit from the central part to a border of the glazed unit,

FIG. 6 schematically shows a cross-section of a soundproofing zone of a glazed unit according to one embodiment of the invention, wherein the soundproofing zone has a recess of the glazed unit,

FIG. 7 schematically shows an isometric view of a soundproofing zone of a glazed unit according to one embodiment of the invention, wherein the soundproofing zone has a recess of the glazed unit,

FIG. 8 schematically shows the profile of a thinning of a soundproofing zone according to one embodiment of the invention,

FIG. 9 schematically shows the profile of a thinning of a soundproofing zone according to one embodiment of the invention,

FIG. 10 schematically shows the profile of a thinning of a soundproofing zone according to one embodiment of the invention,

FIG. 11 schematically shows the profile of a thinning of a soundproofing zone according to one embodiment of the invention,

FIG. 12 schematically shows the profile of a thinning of a soundproofing zone according to one embodiment of the invention,

FIG. 13 schematically shows a glazed unit comprising a visco-elastic dissipator fixedly mounted on the soundproofing zone,

FIG. 14 schematically shows a glazed element according to one embodiment of the invention, comprising two glazed units,

FIG. 15 schematically shows a glazed element according to one embodiment of the invention, comprising two glazed units,

FIG. 16 is a diagram showing the soundproofing of various glazed units based on the frequency of an incident wave to the glazed units,

FIG. 17 is a diagram showing the soundproofing of various glazed units based on an incident wave to the glazed units,

FIG. 18 schematically shows two glazed units, including one curved glazed unit, according to one embodiment of the invention,

FIG. 19 is a diagram showing the soundproofing of various glazed units based on the frequency of an incident wave to the glazed units.

In all the figures, similar elements are marked with identical references.

### Definitions

“Loss factor η” of a material means, the material having a complex Young's modulus, the ratio between the imaginary part E″ of the Young's modulus of the material and the real part E′ of the Young's modulus of the material. The loss factor n of a material is defined by international standard ISO 18437-2:2005 (Mechanical vibration and shock—Characterization of the dynamic mechanical properties of visco-elastic materials—Part 2: Resonance method, part 3.2). Preferentially, the loss factor η can be defined for a predetermined frequency. “A material has a first loss factor η greater than a value” means that the material has a first loss factor η greater than the value for each of the frequencies in the audible frequency range, that is, in a frequency range extending between 20 Hz and 20,000 Hz, inclusive, and preferentially between 20 Hz and 10 kHz, inclusive.

“The real part E′ of the Young's modulus of a material is greater than a value” means that the real part E′ of the Young's modulus of the material is greater than the value of the real part E′ of the Young's modulus of the material for each of the frequencies in the audible frequency range, that is, in a frequency range extending between 20 Hz and 20,000 Hz, inclusive, and preferentially between 20 Hz and 10 kHz, inclusive.

The real part E′ and the imaginary part E″ of the Young's modulus can be defined for a predetermined temperature. The temperature range considered in the present invention is comprised between −90° C. and 60° C. In the present invention, “the real part E′ of the Young's modulus of a material is greater than a value” means that the material has a real part E′ of the Young's modulus greater than the value for each of the temperatures comprised between −90° C. and 60° C. In the present invention, “a material has a first loss factor η greater than a value” means that the material has a first loss factor η greater than the value for each of the temperatures comprised between −90° C. and 60° C.

A dynamic characterization of a material is carried out on a visco-analyzer of the Metravib visco-analyzer type, under the following measurement conditions. A sinusoidal load is applied to the material. A measurement sample made of the material to be measured consists of two rectangular parallelepipeds, each parallelepiped having a thickness of 3.31 mm, a width of 10.38 mm and a height of 6.44 mm. Each parallelepiped made of the material is also referred to as a shear “test specimen”. The excitation is implemented with a dynamic amplitude of 5 μm around the rest position, covering the frequency range comprised between 5 Hz and 700 Hz, and covering a temperature range comprised between −90° C. and +60° C.

The visco-analyzer makes it possible to subject each test specimen (each sample) to deformations under precise temperature and frequency conditions, and to measure the displacements of the test specimen, the forces applied to the test specimen and their phase shift, which makes it possible to measure rheological quantities characterizing the material of the test specimen.

The use of measurements makes it possible especially to calculate the Young's modulus E of the material, and particularly the real part E′ of the Young's modulus and the imaginary part E″ of the Young's modulus of the material, and thus to calculate the tangent of the loss angle (or loss factor) η (also referred to as tan δ).

A value of the real part E′ of the Young's modulus and/or a loss factor η of a material are measured without the material being pre-stressed.

“Glazed unit” is understood to mean a structure comprising at least one sheet of organic or mineral glass, preferentially suitable for being mounted in an aircraft.

The glazed unit can comprise a single glass sheet or a multilayer glazed assembly at least one sheet of which is a glass sheet.

A glazed unit may comprise an organic glass sheet. Preferably, the organic glass is formed by a compound comprising acrylates, preferably by polymethyl methacrylate (PMMA). It also can be formed by polycarbonate.

A glazed unit can comprise a glazed assembly. The glazed assembly comprises at least one glass sheet. The glass can be organic or mineral glass.

The glass can be tempered. The glazed assembly is preferably a laminated glazed unit. “Laminated glazed unit” is understood to mean a glazed assembly comprising at least two glass sheets and an interlayer film formed of plastic material, preferentially viscoelastic, separating the two glass sheets. The interlayer film made of plastic material can comprise one or more layers of a visco-elastic polymer such as polyvinyl butyral (PVB) or an ethylene-vinyl acetate copolymer (EVA). The interlayer film is preferably made of standard PVB or of acoustic PVB (such as single-layer or tri-layer acoustic PVB). Acoustic PVB can comprise three layers: two outer layers of standard PVB and an inner layer of PVB with added plasticizer so as to make it less rigid than the outer layers.

“Ellipse” means a closed planar curve obtained by the intersection of a cone of revolution with a plane, provided that it intersects the axis of rotation of the cone or of the cylinder. The ellipse is a conic section of eccentricity strictly comprised between 0 and 1. The ellipse is also the locus of points whose sum of distances to two fixed points, referred to as foci, is constant.

### DETAILED DESCRIPTION OF THE INVENTION

### General Architecture and Theoretical Elements

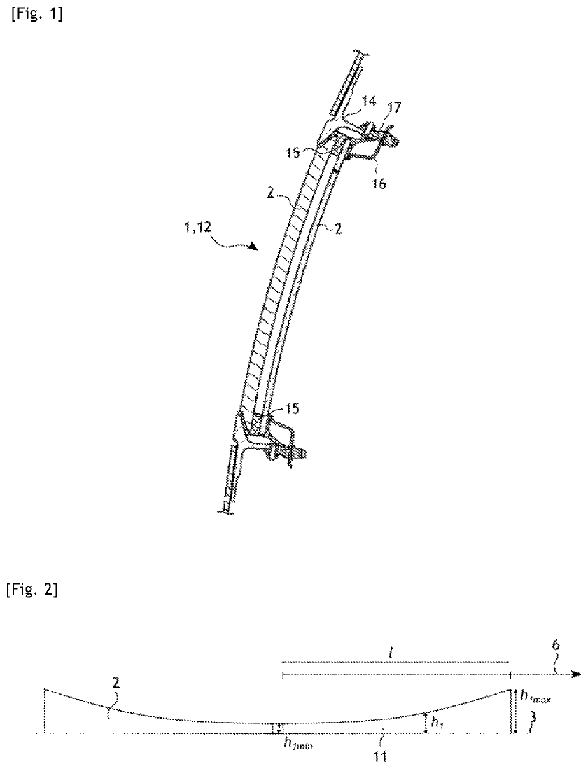

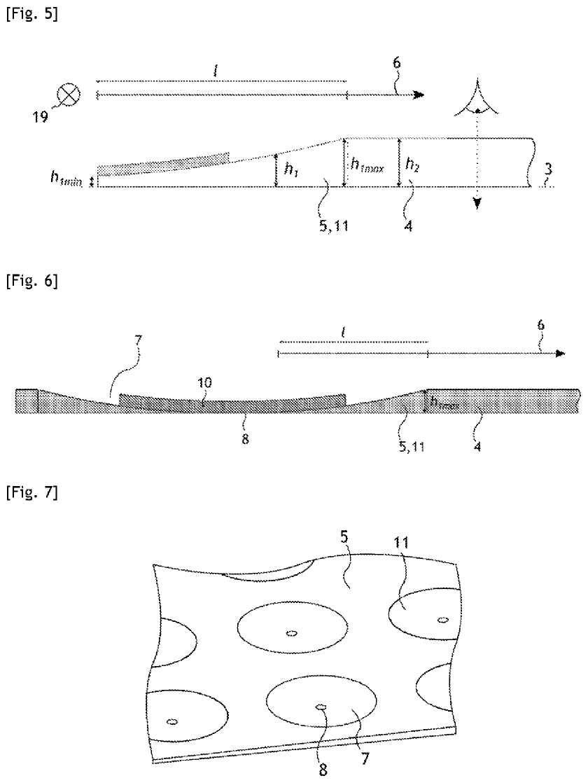

Referring to FIG. 1, to FIG. 5 and to FIG. 6, a glazed unit 2 extends along a main surface 3. The glazed unit 2 is formed by a first material. The glazed unit 2 comprises a soundproofing zone 11 extending along a first length l along the main surface 3.

The soundproofing zone 11 has a first thickness h₁ of the material. The first thickness h₁ varies, based on a coordinate x, along the first length l, proportionally to a value of xⁿ, wherein n is a real number strictly greater than 1, from a minimum thickness h₁ₘᵢₙ until a maximum thickness h₁ₘₐₓ, the first length l being predetermined so that the minimum thickness h₁ₘᵢₙ is less than or equal to one third of the maximum thickness h₁ₘₐₓ. The coordinate x is equal to zero when the thickness h₁ of the soundproofing zone 11 is equal to the minimum thickness h₁ₘᵢₙ. When the coordinate x is equal to the first length l, the thickness h₁ of the soundproofing zone 11 is equal to the maximum thickness h₁ₘₐₓ. The first length l preferably extends in a main direction 6, the main direction 6 being locally parallel to the main surface 3.

Thus, the glazed unit 2 has higher soundproofing than the soundproofing of a known glazed unit.

Indeed, the document Mironov et al. (Mironov, M. A., 1988, “Propagation of a flexural wave in a plate whose thickness decreases smoothly to zero in a finite interval”, Soviet Physics Acoustics-USSR, 34(3), 318-319) describes that a reduction of the thickness of a thin plate on edges can render the edges non-reflective for bending waves in the material of the plate, when the reduction follows a power law, so that the thickness h of the plate is proportional to xⁿ, wherein n is a real number strictly greater than 1.

The thickness h₁ of the glazed unit 2 in the soundproofing zone 11 can be defined by the following formula (1):

$${h}_{1} ( x ) = ε . {x}^{n} \qquad ( 1 )$$

wherein ε is a proportionality factor.

The phase velocity c_{b} of the bending waves can be defined based on the thickness h(x) of the glazed unit 2 by the following formula (2):

$${c}_{b} = {( \frac{{Eh ( x )}^{2} {ω}^{2}}{12 ρ ( 1 - {v}^{2} )} )}^{\frac{1}{4}} \qquad ( 2 )$$

wherein E is the Young's modulus of the material, p is the density of the material, v is the Poisson's ratio of the material, h(x) is the thickness of the plate at the coordinate x and w is the angular velocity of the incident sound wave.

From the phase velocity c_{b} in the soundproofing zone 11, it is possible to calculate a transit time of a bending wave propagating in the soundproofing zone 11. When the thickness h₁ₘᵢₙ tends towards zero thickness, the transit time tends towards infinity. Thus, the incident bending wave is not reflected by an edge of the glazed unit 2, which makes it possible to increase the soundproofing of the glazed unit 2.

The term “acoustic black hole” is used to designate the soundproofing zone 11. The glazed unit 2 comprises at least one acoustic black hole. The glazed unit 2 may comprise a plurality of acoustic black holes, and preferentially an array of acoustic black holes. Referring to FIG. 2, the glazed unit 2 may be entirely formed by an acoustic black hole.

In practice, it is not possible to manufacture a zero thickness h₁ₘᵢₙ. The inventors have observed that the soundproofing effect appears when the first length l is predetermined so that the minimum thickness h₁ₘᵢₙ is less than or equal to one third of the maximum thickness h₁. Especially, the first length l is predetermined so that the minimum thickness h₁ₘᵢₙ is less than or equal to one fifth of the maximum thickness h₁ₘₐₓ. More preferentially, the first length l is predetermined so that the minimum thickness h₁ₘᵢₙ is less than or equal to one tenth of the maximum thickness h₁ₘₐₓ.

The inventors have also observed that the soundproofing effect appears for n strictly greater than 1, especially strictly greater than 5/3, and preferentially strictly greater than 2. Moreover, n can be strictly less than 100, so as to prevent a reflection at the junction between the central part 4 and the peripheral part 5.

The soundproofing zone 11 may have a size greater than or equal to the first length l in a second main direction, the second main direction being locally perpendicular to the first main direction 6 and locally parallel to the main surface 3.

### Adaptation to the Visual Comfort of a User

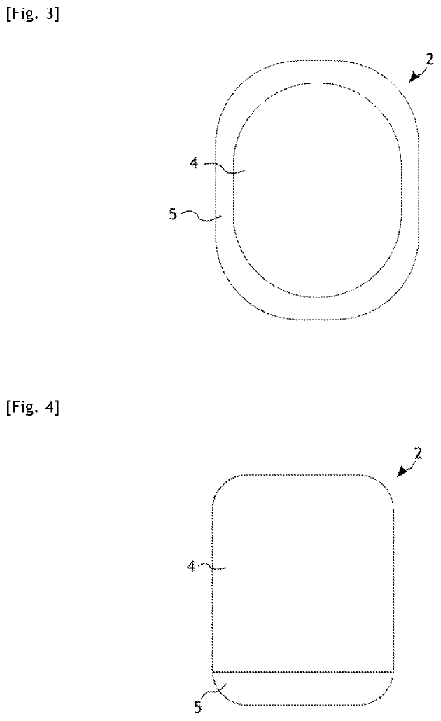

Referring to FIG. 3 and to FIG. 4, the glazed unit 2 comprises a central part 4 and a peripheral part 5. The peripheral part 5 is arranged at the periphery of the central part 4 relative to the main surface 3 and directly in contact with the central part 5, so as to allow transmission of the bending waves between the central part 4 and the peripheral part 4. Thus, the glazed unit 2 has higher soundproofing than the soundproofing of a known glazed unit, while comprising a central part 4 wherein the optical transmission through the glazed unit is not degraded relative to the optical transmission of a known glazed unit.

The central part 4 has a thickness of the first material h₂, and has the maximum thickness h₁ₘₐₓ of the material in contact with the peripheral part 5, in a direction normal to the main surface 3. The peripheral part 5 comprises the soundproofing zone 11.

Referring to FIG. 3, the peripheral part 5 can surround the central part 4 relative to the main surface 3. Referring to FIG. 4, the peripheral part 5 can partially border the central part 4. In particular, the peripheral part 5 can be arranged along an edge of the central part 4. The glazed unit 2 may also include several separate peripheral parts 5 arranged at the periphery of the central part 4 relative to the main surface 3. In particular, the peripheral part 5 can be arranged in contact with two opposite edges of the central part 4.

Referring to FIG. 5, the thickness h₂ of the central part 4 is constant over the entire central part 4. Preferentially, the thickness h₂ of the central part 4 is between 100 μm and 5 cm.

A material forming the peripheral part 5 and a material forming the central part 4 are preferentially the same first material. Thus, the manufacture of the glazed unit 2 is facilitated.

The glazed unit 2 may be a monolithic aircraft glazed unit. Thus, the machining of the soundproofing zone 11 is facilitated, while avoiding reflection of the bending waves at the junction between the central part 4 and the peripheral part 5.

The glazed unit 2 may be formed by an organic glass, in particular by polymethyl methacrylate (PMMA). Thus, the machining of the peripheral part 5 is facilitated with regard to the machining of a soda-lime glass, while allowing the glazed unit 2 to be integrated into a window 12.

### Soundproofing Zone 11

Referring to FIG. 5, the soundproofing zone 11 can form a thinning of the glazed unit 2 from the central part 4 until a border of the glazed unit 2. Preferably, n is a real number greater than or equal to 2. The soundproofing zone 11 thus forms a blade extending in the second main direction 16. Thus, it is possible to increase the soundproofing of the glazed unit 2 with respect to a known glazed unit, while facilitating the manufacture of the glazed unit 2. Preferably, the soundproofing part 2 extends in the second main direction 19 over a length greater than or equal to the length l.

Referring to FIG. 6 and to FIG. 7, the soundproofing zone 11 may have at least one recess 7, n being a real number greater than or equal to 5/3. Preferably, the recess 7 has a minimum size Wₘᵢₙ, according to the main surface 3 greater than or equal to the first length l. The recess 7 can have an elliptical shape, and preferentially a circular shape. An ellipse formed by the recess 7 can have a minimum radius rₘᵢₙ. Preferably, the minimum radius rₘᵢₙ of the ellipse is greater than or equal to the first length l. The recess 7 can also have a square or rectangular shape.

Referring to FIG. 2 and FIG. 6, a cut-out 8 can be formed at the center of the recess 7. Thus, a soundproofing zone 11 having the minimum thickness h₁ₘᵢₙ can be manufactured so that the minimum thickness h₁ₘᵢₙ is as close as possible to a zero thickness, which makes it possible to increase the soundproofing of the glazed unit 2. Preferably, when the recess has an elliptical shape, the first length l is greater than the difference between the radius r or the minimum radius rₘᵢₙ of the recess 7 and the radius of the cut-out.

The modal movements of the glazed unit 2, for frequencies of an incident acoustic wave greater than a cut-off frequency of the soundproofing zone 11, are concentrated around the borders forming the cut-out 8. From the ratio between the minimum thickness h₁ₘᵢₙ and the maximum thickness h₁ₘₐₓ, the cut-off frequency of the glazed unit 2 may be small enough to increase the soundproofing of the glazed unit 2 in an audible frequency range.

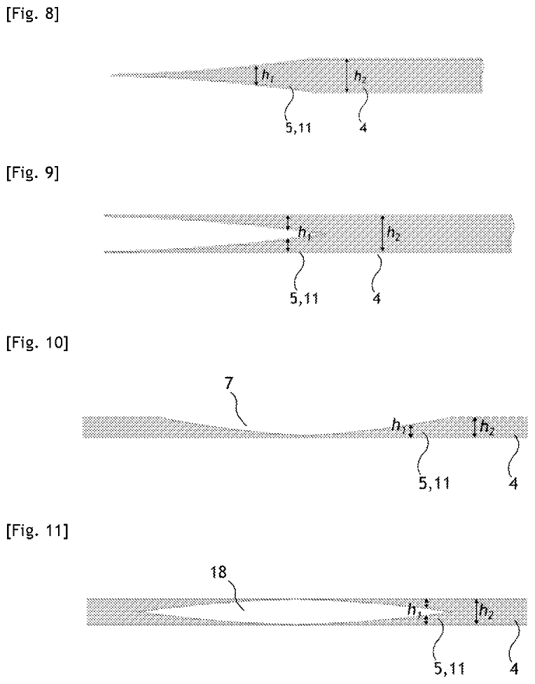

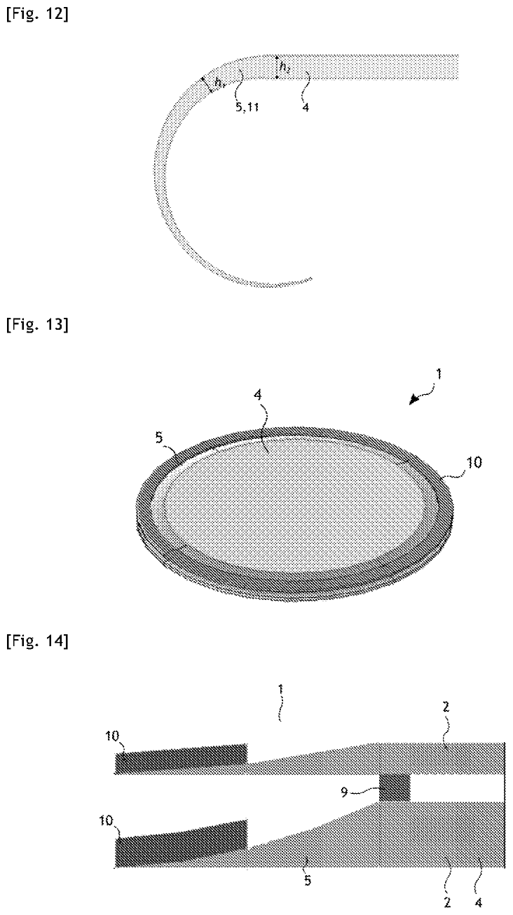

Referring to FIG. 8, to FIG. 9, to FIG. 10, to FIG. 11 and to FIG. 12, the soundproofing zone 11 may have different shapes. Referring to FIG. 8, the material may form an edge at the border of the soundproofing zone 11. Referring to FIG. 9, the material can have a fork-shaped section, the soundproofing zone 11 forming two edges on the border of the soundproofing zone 11. The thickness h₁ can be, in this case, measured by adding the thicknesses of each of the arms of the fork. Referring to FIG. 10, the material may form a recess 7. Referring to FIG. 11, the material may form a cavity 18. In this case, the thickness h₁ of the soundproofing zone 11 is measured by adding the thicknesses of the material forming the cavity in a direction locally perpendicular to the main surface 3. Referring to FIG. 12, the soundproofing zone 11 can extend according to a curved surface. In this case, the measurement of the thickness h₁ of the soundproofing zone 11 is carried out by measuring the thickness of the material in a direction locally perpendicular to the curved surface.

### Visco-Elastic Dissipator 10

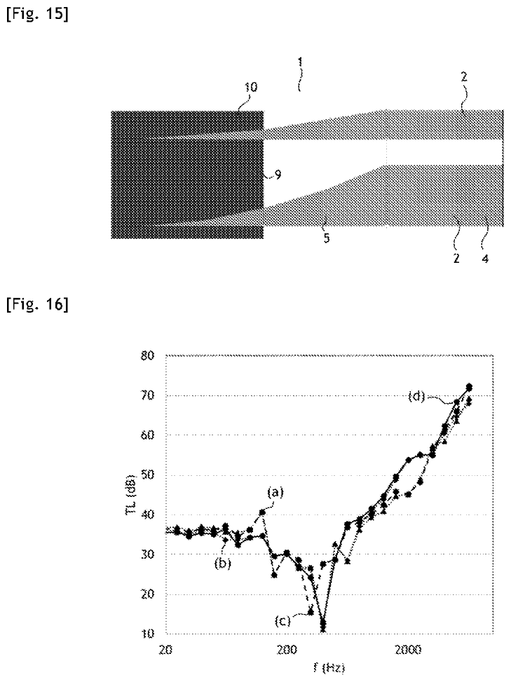

Referring to FIG. 13, to FIG. 14 and to FIG. 15, the glazed unit 2 can comprise a visco-elastic dissipator 10. The dissipator 10 can be mounted secured in contact with at least one part of the soundproofing zone 11. The dissipator 10 can be made of a second visco-elastic material having a first loss factor η₁ strictly greater than 0.05, especially strictly greater than 0.10, and preferentially strictly greater than 0.15. Thus, the energy concentrated in a soundproofing zone 11 by incident bending waves is dissipated in a viscous manner, which makes it possible to reduce the reflection of a bending wave in the glazed unit 2 with respect to a known glazed unit. The second material is visco-elastic, and can have a real part E′ of the Young's modulus less than 100 MPa, and preferentially less than 10 MPa.

Referring to FIG. 13, the dissipator 10 can be mounted secured to a part of the soundproofing zone 11 having a thickness comprised between h₁ₘᵢₙ and h₁ₘₐₓ/2. Thus, the bending waves are dissipated by the visco-elastic dissipator 10 at the location where they are most concentrated. Preferably, a part of the dissipator 10 is in contact with the part of the soundproofing zone 11 having the minimum thickness h₁ₘᵢₙ. Preferably, the dissipator 10 can be formed by a layer of visco-elastic material fixedly mounted on the soundproofing zone, the thickness of the layer of visco-elastic material being greater than h₁ₘᵢₙ/2, in particular greater than h₁ₘᵢₙ, and preferentially greater than h₁ₘₐₓ.

The dissipator 10 can be made of a material selected from a silicone, a nitrile and a polyurethane. Preferably, the second material has a glass transition temperature Tg less than 50° C., and preferentially less than 30° C. Thus, the second material can dampen the bending waves exhibiting audible frequencies. Preferably, the second material may have a mass density greater than 100 kg/m³, in particular greater than 500 kg/m³, and preferentially greater than 1000 kg/m³. The visco-elastic properties of the known materials can be measured by the methods described herein. The material of the dissipator 10 can have a glass transition temperature comprised between −80° C. and −50° C., inclusive. For example, the material of the dissipator 10 can comprise a methyl vinyl silicone rubber (MVQ) crosslinked by a benzoyl peroxide. The material of the dissipator 10 can also be a porous material. The loss factor of the material can also be adjusted by a tackifying agent, for example a glycerin ester, calcium carbonate or carbon nanotubes. For example, the polyurethane sealant Weberseal PU 40 (registered trademark) of the Weber brand for example has a loss factor η equal to 0.41 and a value of the imaginary part E′ of the Young's modulus equal to 7.2 MPa. For example, the polyurethane sealant Sikaflex PRO-11 FC (registered trademark) of the Sika brand for example has a loss factor η equal to 0.20 and a value of the imaginary part E′ of the Young's modulus equal to 1.2 MPa.

### Glazed Element 1 and Window 12

Another aspect of the invention is a glazed element 1. The glazed element 1 comprises at least two glazed units 2. The two glazed units 2 can be superimposed. The glazed element 1 comprises at least one spacer 9 configured to separate the two glazed units 2. Preferably, the glazed element 1 can be an aircraft window 12.

Referring to FIG. 14, the spacer 9 can be a part formed from a third material, having a thickness, arranged in contact with each of the two glazed units 2, each of the glazed units being in contact on both sides of the part. The third material may have a value of the real part E of the Young's modulus strictly less than 20 MPa, and preferentially strictly less than 10 MPa. Thus, the incident bending waves, from the central part 4 to the peripheral part 5, can be transmitted to the peripheral part 5 without being reflected by too high a rigidity of the material of the central part 4 imposed by a rigid spacer. The third material may have a mass density greater than 100 kg/m³, in particular greater than 500 kg/m³, and preferentially greater than 1000 kg/m³. The third material may have a damping factor strictly greater than 0.05, especially strictly greater than 0.10, and more preferentially greater than 0.5. The third material and the second material may be the same material.

The part forming a spacer 9 may be a seal arranged between the two glazed units 2. The part forming a spacer 9 may be arranged on the central part 4 of each of the two glazed units 2, at the border of the peripheral part 5. Thus, the spacer 9 does not obstruct the light transmission through the central part 4.

Referring to FIG. 15, the spacer 9 may be a seal configured to receive each of the glazed units 2. The spacer 9 may preferentially comprise two recesses, preferentially two notches, each housing being configured to receive a border of a glazed unit 2. The border of the glazed unit 2 received by the housing may be the peripheral part 5.

The spacer 9 may comprise the visco-elastic dissipator 10. In this case, a part of the spacer 9 configured to receive a glazed unit 2 is formed by a third material having a first loss factor η₁ strictly greater than 0.05, especially strictly greater than 0.10, and preferentially strictly greater than 0.15. Thus, the energy concentrated in a soundproofing zone 11 by incident bending waves is dissipated in a viscous manner, which makes it possible to reduce the reflection of a bending wave in the glazed unit 2 with respect to known glazed units.

FIG. 16 shows a soundproofing of different glazed units based on the frequency of an incident acoustic wave. Curve (a) shows a soundproofing of a known window, comprising two superimposed glazed units separated by an air thickness. Curve (b) shows a soundproofing of a window 2 according to one embodiment of the invention, comprising two superimposed glazed units separated by an air thickness. The thicker of the two glazed units comprises an acoustic black hole, formed by a thinning of the glazed unit 2 from the central part 4 to a border of the glazed unit 2. Curve (c) shows a soundproofing of a window 2 according to one embodiment of the invention, comprising two superimposed glazed units 2 separated by an air thickness. The less thick of the two glazed units comprises an acoustic black hole, formed by a thinning of the glazed unit 2 from the central part 4 to an edge of the glazed unit 2. Curve (b) shows a soundproofing of a window 2 according to one embodiment of the invention, comprising two superimposed glazed units 2 separated by an air thickness. Each glazed unit 2 comprises an acoustic black hole, formed by a thinning of the glazed unit 2 from the central part 4 to a border of the glazed unit 2.

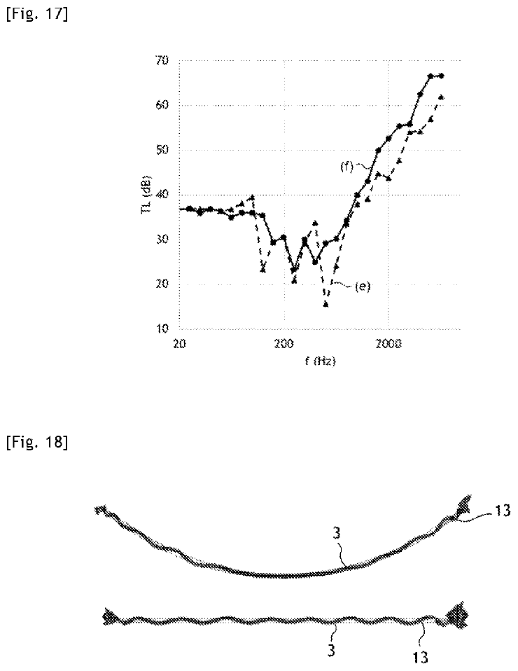

FIG. 17 shows a soundproofing of a known glazed unit through a glazed unit according to one embodiment of the invention, based on the frequency of an incident acoustic wave. Curve (e) shows a soundproofing of a known window. The window comprises a first glazed unit of circular shape having a thickness of 12.7 mm, and a second glazed unit of circular shape having a thickness of 6.1 mm. The diameter of each of the glazed units is equal to 520 mm. The two glazed units are spaced apart by 5 mm of air. Curve (f) shows soundproofing of a window 2 according to an embodiment of the invention. The window 2 comprises a first glazed unit of circular shape having a thickness h₁ of the central part 4 of 12.7 mm, and a second glazed unit of circular shape having a thickness h₁ of the central part 4 of 6.1 mm. The diameter of each of the glazed units is equal to 520 mm. The two glazed units are spaced apart by 5 mm of air. Each of the first glazed unit 2 and the second glazed unit 2 comprises an acoustic black hole, formed by a thinning of the glazed unit 2 from the central part 4 to a border of the glazed unit 2. Each glazed unit 2 comprises a dissipator 10, fixedly mounted on the soundproofing zone 11 of the glazed unit.

### Windshield 13

Another aspect of the invention is an aircraft windshield 13, comprising a glazed unit 2 according to one embodiment of the invention. Preferably, the glazed unit 2 has a curved main surface 3. Referring to FIG. 18, the inventors have discovered that a glazed unit 2, having a curved main surface 3 and comprising at least one acoustic black hole, exhibits an increase in the soundproofing with respect to the same glazed unit in the absence of an acoustic black hole.

Preferably, the windshield 13 comprises a single glazed unit 2.

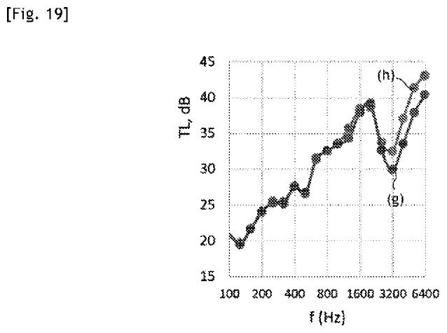

FIG. 19 shows soundproofing of a known windshield and a windshield 13 according to one embodiment of the invention. Curve (g) shows a soundproofing of a known windshield. The windshield is formed by a PMMA glazed unit, and the main surface 3 of the windshield has a radius of curvature equal to 800 mm. Curve (h) shows a soundproofing of a windshield 13 according to an embodiment of the invention. The windshield 13 is formed by a PMMA glazed unit 2, and the main surface 3 of the windshield has a radius of curvature equal to 800 mm. The windshield 13 comprises two peripheral parts 5, arranged on both sides of the windshield 13. Each peripheral part 5 comprises an acoustic black hole. Each acoustic black hole is formed by a thinning of the glazed unit 2 from the central part 4 to a border of the glazed unit 2.

Alternatively, a glazed unit 2 is suitable for use in vehicles other than an aircraft, such as a motor vehicle, or a train.

1. A glazed unit extending along a main surface and formed by a first material, the glazed unit comprising a soundproofing zone that extends along a first length l along the main surface, the soundproofing zone having a first thickness h₁ of the material, the first thickness h₁ varying, as a function of a coordinate x, along the first length l in proportion to a value of xⁿ, where n is a real number strictly greater than 1, from a minimum thickness h₁ₘᵢₙ to a maximum thickness h₁ₘₐₓ, the first length l being predetermined such that the minimum thickness h₁ₘᵢₙ is less than or equal to one third of the maximum thickness h₁ₘₐₓ.

2. The glazed unit according to claim 1, comprising a central part and a peripheral part, the peripheral part being arranged at a periphery of the central part relative to the main surface and directly in contact with the central part, wherein:
the central part has a first thickness h₁ₘₐₓ of the material in contact with the peripheral part,
the peripheral part comprises the soundproofing zone.

3. The glazed unit according to claim 1, the glazed unit being a monolithic aircraft glazed unit.

4. The glazed unit according to claim 1, wherein the soundproofing zone forms a thinning of the glazed unit from the central part until a border of the glazed unit.

5. The glazed unit according to claim 4, wherein the central part has two opposite edges, and wherein the peripheral part is arranged in contact with the two edges.

6. The glazed unit according to claim 1, wherein the soundproofing zone has at least one recess.

7. The glazed unit according to claim 1, comprising a visco-elastic dissipator, wherein the dissipator is mounted secured in contact with at least one part of the soundproofing zone, the dissipator being made of a visco-elastic material having a first loss factor η₁ strictly greater than 0.05.

8. A glazed element comprising at least two glazed units, each glazed unit being a glazed unit according to claim 1, the at least two glazed units being superimposed, the glazed element comprising at least one spacer configured to separate the two glazed units.

9. The glazed element according to claim 8, wherein the spacer is formed by a visco-elastic material having a value of the real part of the Young's modulus E′ less than 20 MPa.

10. An aircraft window comprising a glazed unit according to claim 1.

11. An aircraft windshield, comprising a glazed unit according to claim 1.

12. The glazed unit according to claim 7, wherein the first loss factor η₁ is strictly greater than 0.10.

13. The glazed unit according to claim 12, wherein the first loss factor η₁ is strictly greater than 0.15.
